(19) United States
(12) Patent Application Publication
(10) Pub. No.: US 2006/0257615 A1
(43) Pub. Date: Nov. 16, 2006

(54) Three-dimensional optical recording medium and optical disk cartridge

(75) Inventors: Hiroaki Takano, Kanagawa (JP); Noriko Inoue, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/417,206

(22) Filed: May 4, 2006

(30) Foreign Application Priority Data
May 10, 2005 (JP) 2005-136794

(51) Int. Cl. B32B 3/02

(52) U.S. Cl. 428/64.4

(57) ABSTRACT

A three-dimensional optical recording medium includes: an optical information recording layer and a recording portion that stores managing information of the three-dimensional optical recording medium. The recording portion is optically or electromagnetically readable, for example, a barcode, an RFID tag, a magnetic recording material, and is disposed at a periphery of the three-dimensional optical recording medium which may be formed in a disk or in a card. An optical disk cartridge including a cartridge case for housing the medium as optical disk cartridge has the recording portion at the medium or the cartridge case.

### BACKGROUND OF THE INVENTION

1. Field of the Invention

The present invention relates to a three-dimensional optical recording medium such as a two photon absorption memory and a holographic memory and an optical disk cartridge including the three-dimensional optical recording medium.

2. Description of the Related Art

Three-dimensional recording media having an increased capacity for storing information in a thickness direction of the optical recording medium in addition to two-dimensional storing performed in recording media such as a CD (compact disk) and a DVD (digital video disc) are known.

As a method of recording information in the three-dimensional optical recording medium, are known a method of recording information in an optical recording layer using holography (interference) and a method of recording the information in which two photon absorbing material is used for recording. Japanese laid-open patent application publication No. 2001-005368 discloses this at paragraphs from 0013 to 0023. Such a three-dimensional optical recording medium is useful as an optical recording medium for archiving data with a professional-use specification because of the increased recording capacity.

### SUMMARY OF THE INVENTION

An aspect of the present invention provides a three-dimensional optical recording medium comprising, an optical information recording layer for three-dimensionally storing optical information; and a recording portion that stores managing information of the three-dimensional optical recording medium.

The “managing information” may be any type of information useful for a user to manage the three-dimensional optical recording medium such as production information (production managing information), an index of the optical information recorded in the three-dimensional optical recording medium, identification information of the user, and encrypting information related to the optical information recorded.

This three-dimensional optical recording medium may allow the user to manage the three-dimensional optical recording medium on the basis of the managing information read out from the recording portion.

Further, in such a three-dimensional optical recording medium, the managing information in the recording portion may be optically readable or electromagnetically readable. The optically readable recording portion may be a printed character or a barcode. The electromagnetically readable portion may be an RFID (Radio Frequency Identification) tag or a magnetic optical recording medium.

In addition, the three-dimensional optical recording medium may be a disk or a card. Further, the recording portion for the managing information may be disposed at a periphery of the three-dimensional optical recording medium. In this case, a recording capacity of the optical information can be increased because the optical information is recorded in a broad area other than the periphery.

The three-dimensional optical recording medium having the disk shape may have a center hole for allowing a driving shaft of a recording and reproducing apparatus to fit in it. In this case the recording portion may be adjacent to the center hole (inner periphery).

Another aspect of the present invention provides an optical disk cartridge comprising: a three-dimensional optical recording medium including an optical information recording layer for three-dimensionally storing optical information; a cartridge case for housing the three-dimensional optical recording medium; and a recording portion that stores managing information of the three-dimensional optical recording medium.

In this case, the user can manage the three-dimensional optical recording medium on the basis of the managing information read out from the recording portion of the disk cartridge. The optical disk cartridge may have a light shielding property for the optical information recording layer.

### BRIEF DESCRIPTION OF THE DRAWINGS

The object and features of the present invention will become more readily apparent from the following detailed description taken in conjunction with the accompanying drawings in which:

FIG. 1A is a perspective view of an optical disk cartridge according to an embodiment of the present invention;

FIG. 1B is a perspective bottom view of the optical disk cartridge according to the embodiment of the present invention;

FIG. 2A is a perspective view of a three-dimensional optical recording medium according to the embodiment of the present invention;

FIG. 2B is an enlarged view X shown in FIG. 2A;

FIG. 3 is a partial, enlarged view of the light shielding cartridge case to show an RFID tag;

FIG. 4 is a schematic drawing of a recording and reproducing apparatus for the optical disk cartridge;

FIG. 5 is a perspective view of the optical recording medium according to a first modification of the present invention;

FIG. 6 is a sectional view of the optical recording medium according to a second modification of the present invention; and

FIG. 7 is a perspective view of the optical recording medium according to a third modification of the present invention.

The same or corresponding elements or parts are designated with like references throughout the drawings.

### DETAILED DESCRIPTION OF THE INVENTION

Prior to describing an embodiment of the present invention, the above-mentioned related art will be further argued. In the three-dimensional optical recording medium for professional use, a reliability of the optical recording medium itself is important when it is in use. Thus, it is desirable to record managing information usable for a user such as a manufacturing lot and a part lot on each of three-dimensional optical recording medium. Further, the three-dimensional optical recording medium capable of managing each file is useful because it can store data of a content of archived information.

The present invention provides a three-dimensional optical recording medium capable of storing managing information and an optical disk cartridge containing the three-dimensional optical recording medium.

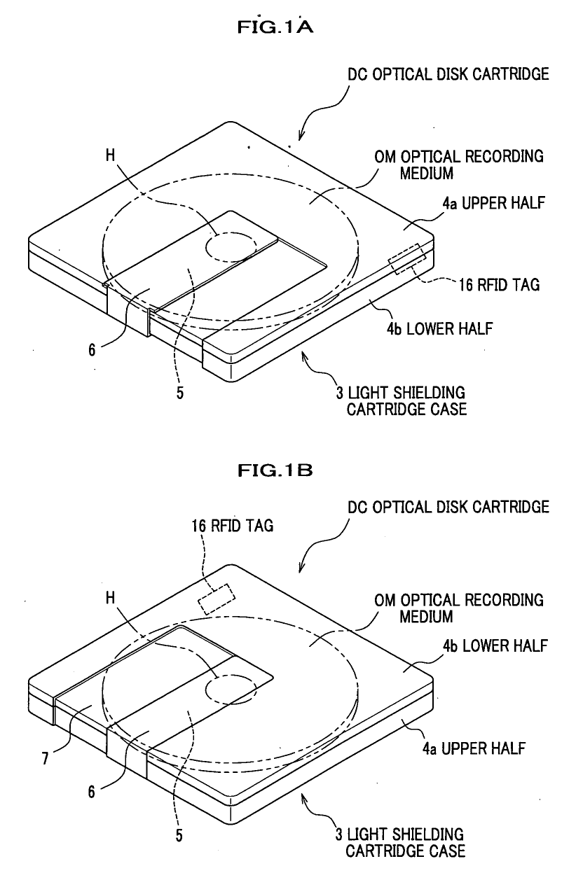

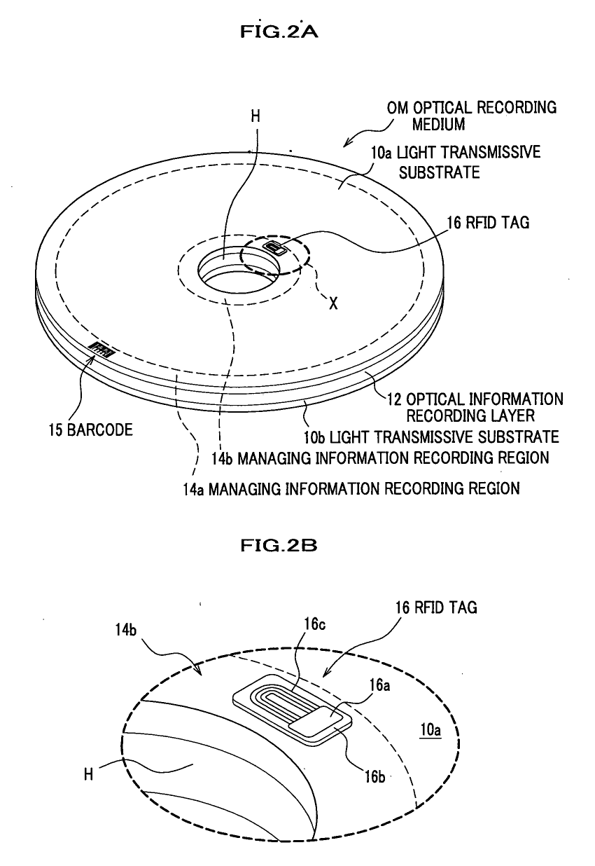

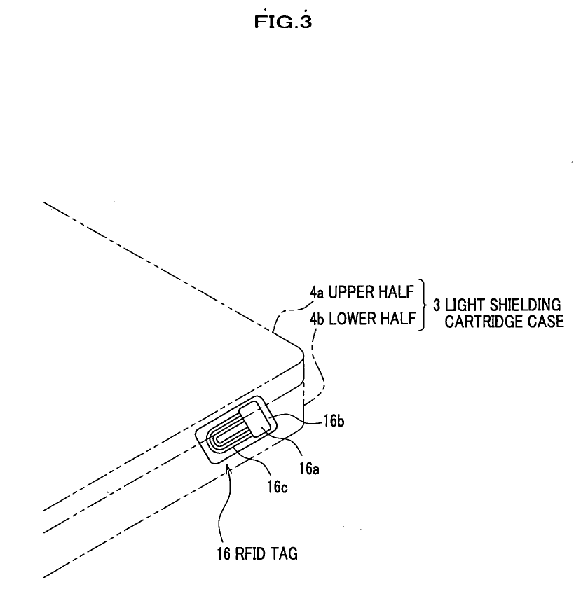

Hereinafter with reference to drawings will be described in details an embodiment of the present invention. FIG. 1A is a perspective view of an optical disk cartridge of an embodiment. FIG. 1B shows a bottom view of the optical disk cartridge shown in FIG. 1A. FIG. 2A is a perspective view of a three-dimensional optical recording medium OM (hereinafter, simply referred to as “optical recording medium OM”) of the embodiment. FIG. 2B is an enlarged view at a part X shown in FIG. 2A. FIG. 3 is a partial, enlarged view showing an RFID (Radio Frequency Identification System) tag 16 in the optical disk cartridge.

In this embodiment, as an example of the three-dimensional optical recording medium, will be described the optical recording medium OM for storing optical information using holography (interference). As shown in FIGS. 1A and 1B, the optical disk cartridge DC includes the optical recording medium OM and a light shielding cartridge case 3 for housing the optical recording medium OM.

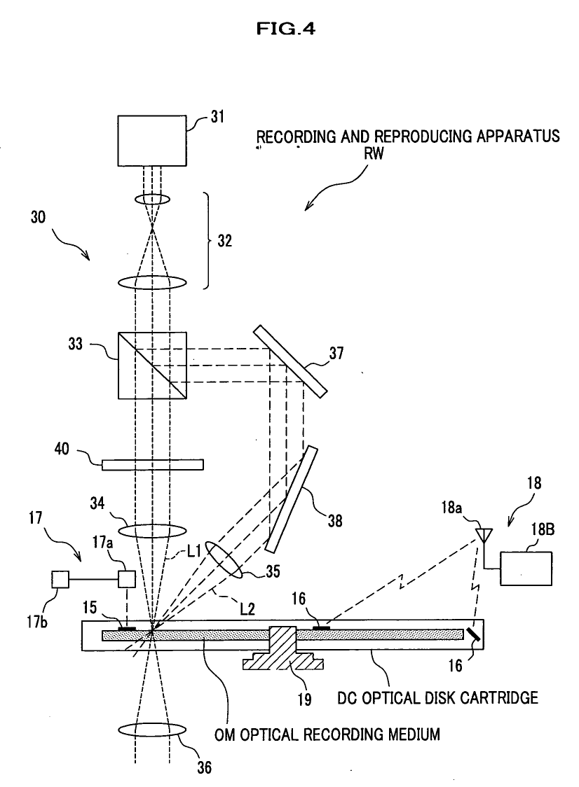

The optical recording medium OM is formed in a disk as shown in FIG. 2A in which a canter hole H is formed at a center thereof to be fitted in a driving shaft 19 (see FIG. 4) of a recording and reproducing apparatus RW (see FIG. 4). The optical recording medium OM includes a pair of light transmissive substrates 10a and 10b and an optical information recording layer 12.

The light transmissive substrates 10a and 10b have disk forms in which center holes corresponding to the center hole H are formed, respectively, for sandwiching and holding the optical recording layer 12. Thicknesses of the light transmissive substrates range from 0.1 to 0.6 mm, respectively.

The light transmissive substrate 10a has a recording region 14a along an outer periphery thereof for storing the managing information of the optical recording medium OM (the optical disk cartridge DC), and a recording region 14b along an inner periphery around the center hole H for storing the managing information of the optical recording medium OM (the optical disk cartridge DC).

Among the managing information of the optical recording medium OM, is listed any information useful for a user to manage the optical recording medium OM such as a production lot of each optical recording medium OM, production information of part lots of parts configuring the optical recording medium OM, information of a recording content of the optical recording medium OM, a using state of the optical recording medium OM, an index of the optical information recorded in the optical recording medium OM, a recording and reproducing record of the optical information in the optical recording medium OM, and a recording and reproducing condition of the optical information in the optical recording medium OM.

The optical recording medium OM records the managing information in a barcode 15 in the recording region 14a as well as in the RFID tag 16 adhered in the recording region 14b. The RFID tag 16 has a well-known configuration and has a substantially rectangular form with a small thickness. The RFID tag 16 includes an IC (Integrated Circuit) chip as a core sealed in a globe top 16a with sealant made of a resin, and a loop antenna 16c printed on a substrate 16b wired to the IC chip. The loop antenna 16c has substantially a rectangular form in which a plurality of turns of a conductor are formed along an outer periphery of the substrate 16b. The RFID tag 16 transmits a signal (in this embodiment, a managing information signal) to the transmitter-receiver unit 18 (see FIG. 4) of the recording and reproducing apparatus RW and receives the signal therefrom through the loop antenna 16c to record the managing information in the above-mentioned IC chip readably.

These light transmissive substrates 10a and 10b are composed of for example, an inorganic substance such as glass and synthetic resins such as a polycarbonate, triacetylcellulose, cycloolefin polymer, polyethylene terephthalate, polyphenylene sulfide, acrylic resin, methacrylic resin, polystyrene resin, vinyl chloride resin, epoxy resin, polyester resin, and amorphous polyolefin. Specifically, glass, polycarbonate, and triacetylcellulose are preferable because of a lower double refractivity. The light transmissive substrates 10a and 10b may be formed of a same material, or of different materials. At surfaces of the light transmissive substrates 10a and 10b may be provided an antireflection coating, an oxygen anti-permeable coating, a moisture anti-permeable coating, a UV cut coating, and the like as needed.

The optical information recording layer 12 is a disk member having a hole, at the middle thereof, corresponding to the center hole H and disposed between the light transmissive substrates 10a and 10b. The optical information recording layer 12 is a layer for recording the optical information by being irradiated with light and formed of a photosensitive resin composition (photopolymer medium forming material) of which thickness is from 0.5 to 2.0 mm and preferably from 1.0 to 2.0 mm. The photosensitive resin composition contains a polymeric monomer, a sensitizing dye, a polymerization initiator, and a binder.

A polymeric monomer is not specifically limited if it has a polymerization group. For example, a radical polymeric monomer or a cation polymeric monomer or both polymeric monomers may be simultaneously used, and to be more precise, compounds containing a polymerization group such as an epoxy group and an ethylene unsaturated group can be used. A polymeric monomer containing one or more of these polymerization groups in a molecule is used, and when containing two or more of these polymerization groups in the molecule, they may be different or same.

As the sensitizing dye is used one having an absorption peak in a wavelength of later-mentioned recording light (reference light), and a light absorption efficiency E of the dye itself is preferably low in the wavelength of the recording light (reference light). As the sensitizing dye can be used known organic dyes such as a cyan, merocyan, phthalocyan, azo, azomethine, indoaniline, xanthene, coumarin, polymethine, diarylethene, fulgide fluorane, anthraquinone, and styryl. Among the polymerizing initiator are a radical precursor, a cation generator, and an acid generator and the like. As examples of the binder can be cited chlorinated polyethylene, polymethylmethacrylate, a copolymer of methylmethacrylate and (meta) acrylate alkylester other than methylmethacrylate, a copolymer of vinyl chloride and acrylonitrile, polyvinyl acetate, polyvinyl alcohol, polyvinyl methylal, polyvinyl butyral, polyvinyl pyrrolidone, ethylcellulose, accetylcellulose, and polycarbonate.

It is preferable that the binder has a large difference in refractivity from that of the polymeric monomer. The photosensitive resin composition may, if necessary, appropriately contain something regularly used for forming an optical information recording layer of this kind of optical recording medium, such as a sensitizer, an optical brightening agent, an ultraviolet ray absorbing agent, a thermal stabilizer, a chain transfer agent, an elasticizer, and a coloring agent.

Further, other materials useable for a known optical recording medium in which the optical information is recorded by hologram can be used for the material of the optical information recording layer 12.

As other materials can be used a silver halide, a gelatin bichromate, a photorefractive material, a photochromic material, and the like. Further, as the material of the optical information recording layer 12, for example, a material for causing a change in refractive index accompanied with coloring and decoloring the dye. The materials of the optical information recording layer 12 can be used in an appropriate combination including, for example, a material including a dye colored or decolored by irradiation of the light on the photosensitive resin composition or a photorefractive material contained in the photosensitive resin composition.

In addition, the optical information recording layer 12 may be made of a heat polymeric resin composition (heat hardening resin composition) in place of the photosensitive resin composition depending on the method of recording.

Next will be described the light shielding cartridge case 3. The light shielding cartridge case 3 is housing configured, as shown in FIG. 1A, by combining an upper half 4a with a lower half 4b and has an opening 5 for causing the optical recording medium OM to be externally exposed. The opening 5 is formed, as shown in FIGS. 1A and 1B, to extend into the upper half 4a and the lower half 4b to cause a part of the optical recording medium OM (including the recording regions 14a and 14b) and the center hole H to externally be exposed. To the opening 5, is provided a slide shutter 6. The slide shutter 6 is a plate member, having a light shielding property, bent in a U-shape and is actuated in such a direction as to close the opening 5 by a spring (not shown). When the optical disk cartridge DC is inserted in the recording and reproducing apparatus RW (see FIG. 4), the slide shutter 6 slides in such a direction that the opening 5 is opened by a driving mechanism (not shown) provided on a side of the recording and reproducing apparatus RW, i.e., in a direction opposite to an actuating force by a spring or the like.

The light shielding cartridge case 3 has, as shown in FIG. 3, the RFID tag 16 inside thereof at a corner thereof. The RFID tag 16 is a provided to record the above-mentioned managing information of the optical recording medium OM. The RFID tag 16 includes the loop antenna 16c on the substrate 16b and the IC chip (not shown) buried in the globe top 16a, and thus, one similar to that for the RFID tag 16 (see FIG. 2A) for the light transmissive substrate 10a can be used for the RFID tag 16 of the light shielding cartridge 3 shown in FIG. 3. The managing information recorded in the light shielding cartridge case 3 may be the same as or different from that recorded in the RFID tag 16 of the optical recording medium OM.

The light shielding cartridge case 3 is made of a light shielding material having a transmittance not greater than 1%, preferably from 0.01 to 0.5% in visual and ultraviolet ray ranges. The upper half 4a, the lower half 4b, and the slide shutter 6 may be made of the same or different light shielding material.

Among materials used for the light shielding cartridge case 3 are listed metal, a resin, and glass. If a resin or glass is used for the light shielding cartridge case 3, it is allowed to a contain dye or a pigment to improve a light shielding property.

Will be described a method of using the optical disk cartridge DC. Prior to describing the method of using the optical disk cartridge DC, will be described a recording and reproducing apparatus for the optical disc cartridge DC. FIG. 4 is a schematic drawing showing the recording and reproducing apparatus RW for the optical disk cartridge DC.

As shown in FIG. 4, the recording and reproducing apparatus RW for the optical disk cartridge DC includes the driving shaft 19 for rotating the optical recording medium OM, a transmitter-receiver unit 18 for contactlessly communicating with the RFID tag 16 disposed in the optical disk cartridge DC, a barcode reading unit 17 for reading the barcode 15 formed on the optical disk cartridge DC, and an optical system 30 for recording the optical information on the optical recording medium OM and reproducing the optical information therefrom.

The transmitter-receiver unit 18 is so configured to transmit the signal to the loop antenna 16c (see FIG. 2B) of the RFID tag 16 and receive the signal therefrom through an antenna 18a as well as to acquire a content of the managing information recorded in the RFID tag 16 with the transmitter-receiver circuit 18b on the basis of the signal. The transmitter-receiver circuit 18b may have the same configuration as one used in a known RFID system, and thus includes, for example, an interface, a CPU (Central Processing Unit), and a memory.

In the barcode reading unit 17, a barcode reading circuit 17b is electrically connected to the barcode reading sensor 17a to acquire the content of the managing information recorded on the barcode 15 on the basis of the barcode detection signal read with the barcode reading sensor 17a. The barcode reading circuit 17b may have the same configuration as one used in a known barcode system, and thus includes, for example, an interface, a CPU, and a memory.

The optical system 30 is configured to produce recording light L1 by passing YAG laser light having wavelength of 532 nm generated by a YAG laser light source 31 through a beam expander 32, a beam splitter 33, a spatial modulator 40, and a Fourier transform lens 34 to irradiate a surface of the optical recording medium OM with the recording light L1. Further, the optical system 30 splits the YAG laser light with the beam splitter 33 to generate reference light L2 through a mirror 37, a mirror 38, and a Fourier transform lens 35 to mix it with the recording light L1. As a result, in the recording and reproducing apparatus RW, an interference pattern is formed which hologram-records the optical information. More specifically, at a bright part of the interference pattern, photopolymer is formed by polymerization. At a shadow part of the interference pattern, polymerizing monomers in a photosensitive resin composition move to the bright part of the interference pattern. As a result, the bright part of the interference pattern becomes polymer-rich and the shadow part of the interference pattern becomes binder-rich, so that the optical information is recorded in the optical information recording layer 12 as an interference pattern appearing as difference in a refractivity and light transmittance.

In this recording and reproducing apparatus RW, an incident angle of the reference light L2 on the optical recording medium OM can be changed by adjusting a reflection angle of the mirror 38 and moving the optical system 30 to record the optical information by an angular multiplexing method. In this embodiment, a spot of the recording light L1 on the surface of the optical recording medium OM is set to have a diameter of 1 mm.

Further, in this recording and reproducing apparatus RW, the optical information is reproduced by irradiating the interference pattern recording the optical information with the reference light L2 of which incident angle is adjusted to that used during recording. The reproduced optical information is read out with an optical sensor (not shown) such as a CCD (charge-coupled device) through an inverse Fourier transform 36.

Next, will be described a method of using the optical cartridge DC.

First, when the optical disk cartridge DC is loaded in the recording and reproducing apparatus RW, the opening 5 (see FIG. 1A) of the light shielding cartridge case 3 is opened by sliding the slide shutter 6 (see FIG. 1A). Next, as shown in FIG. 4, the driving shaft 19 is inserted in the center hole H as well as the barcode 15 of the optical recording medium OM is exposed through the opening 5 by rotation of the driving shaft 19. In this event, the barcode reading sensor 17a of the barcode reading unit 17 supplies to the barcode reading circuit 17b the barcode detection signal corresponding to the barcode 15 as well as the barcode reading circuit 17b acquires the managing information recorded in the barcode 15.

Further, the barcode reading circuit 18b of the transmitter-reciever unit 18 transmits a request signal for the managing information through the antenna 18a. On the other hand, the RFID tag 16 receives the request signal through the loop antenna 16c and then receives a signal indicating the managing information recorded in the above-mentioned IC chip in response to the request signal. The transmitter-receiver unit 18 receives the signal of the managing information through the antenna 18a, as well as the barcode reading circuit 18b acquires the managing information recorded in the RFID tag 16. The managing information acquired by the barcode reading unit 17 and the transmitter-receiver unit 18 is displayed on a display monitor (not shown) such as an LCD (liquid crystal display).

Next, the optical information is recorded as mentioned above by irradiating the optical recording medium OM with the recording light L1 and reproduced as mentioned above by irradiating the optical recording medium OM with the reference light L2.

The optical recording medium OM and the optical disk cartridge DC according to the present invention allow the user to record the managing information useful for managing the optical recording medium OM in a recording portion such as the barcode 15 and the RFID tag 16, so that the user can manage the optical recording medium OM on the basis of the managing information read from the recording portion.

The managing information of the optical recording medium OM includes, for example, the production lot of each optical recording medium OM, the production information of the part lots of the parts configuring the optical recording medium OM, the information of a recorded content in the optical recording medium OM, the using state of the optical recording medium OM, the index of the optical information recorded in the optical recording medium, the recording and reproducing record of the optical information of the optical recording medium OM, and the recording and reproducing conditions of the optical information for the optical recording medium OM. As a result, this optical recording medium OM can improve reliability during use and facilitate to manage the optical information recorded in the optical recording medium OM.

In addition, the optical recording medium OM has a recording system for contactlessly reading the managing information such as the barcode 15 and the RFID tag 16, so that the managing information can be readily read out the managing information even though the optical recording medium OM is rotated by the recording and reproducing apparatus RW.

Further, the optical disk cartridge DC can store the managing information in the RFID tag 16 at the light shielding cartridge case 3 in addition to the RFID tag 16 at the optical recording medium OM. This increases a recording capacity of the managing information of the optical recording medium OM.

The embodiment of the present invention is described above. However, the present invention is not limited to the above-mentioned embodiment, but can be modified. For example, in the embodiment, the optical information is recorded in the optical recording medium OM in response to loading the optical disk cartridge DC on the recording and reproducing apparatus RW. However, the present invention may be embodied such that the optical recording medium OM itself is simply load on the recording and reproducing apparatus RW.

FIG. 5 shows a first modification to illustrate this. The optical recording medium OM not contained in the cartridge case. In a case that the optical recording medium OM itself is simply used, the optical recording medium OM is contained and sealed in a light shielding bag (not shown) for storage. The recording portion for recording the managing information may be provided on the light shielding bag.

Further, in the above-mentioned embodiment, the RFID tag 16 is adhered on the optical recording medium OM. However, the present invention is not limited to this. For example, the RFID tag 16 may be berried in the optical recording medium OM as shown in FIG. 5.

In the above-mentioned embodiment, the optical recording medium OM including the barcode 15 and the RFID tag 16 as the recording portion. However, the present invention is not limited to this, but at least one of the recording region 14a and the recording region 14b are colored or a filter having a predetermined pass band is adhered on at least one of the recording region 14a and the recording region 14b. In this case, wavelengths from the recording regions 14a and 14b is previously related with predetermined managing information to be recorded in the optical recording medium OM (optical recording layer 12). For example, if the wavelength from the recording regions 14a and/or 14b is 500 to 550 nm, the recording capacity of the optical recording medium OM (optical recording layer 12) is 100 GB, and if the wavelength from the recording regions 14a and/or 14b is 600 to 650 nm, the recording capacity of the optical recording medium OM (optical recording layer 12) is 200 GB. Therefore, the recording capacity of the optical recording medium OM can be acquired as the managing information by measuring the wavelength of the light from the recording regions 14a and 14b. In addition, such relating can be made by using difference in intensity of reflection light from the recording regions 14a and 14b.

In addition, the record of the managing information may be optically or magnetically recorded at a periphery of the optical recording medium OM.

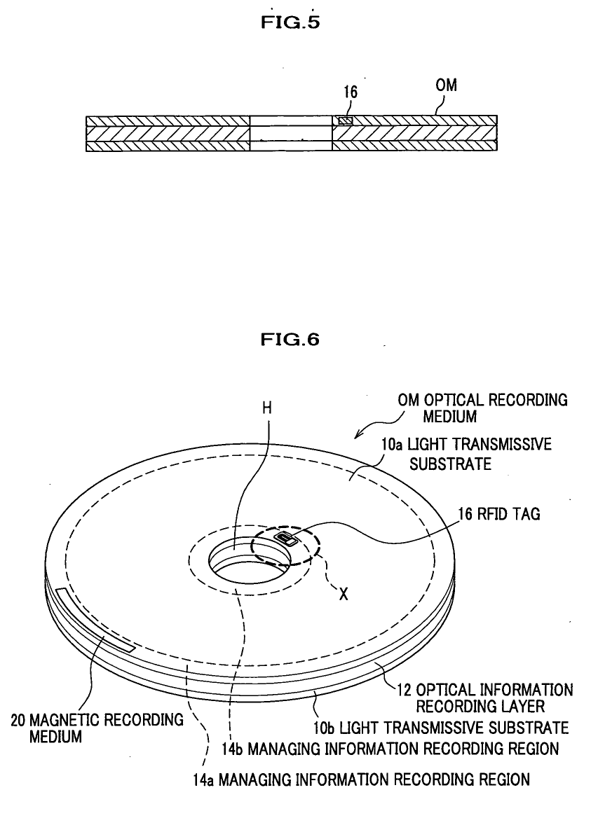

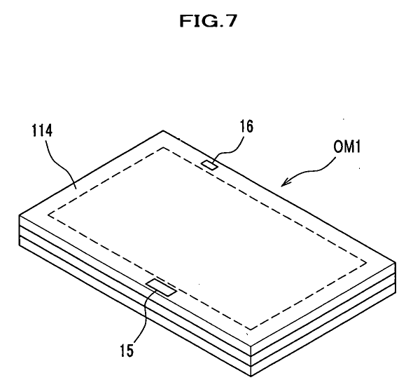

FIG. 6 shows a second modification to illustrate this. The barcode 15 shown in FIG. 2A is replaced with a magnetic recording medium 20 having a stripe curved along the circumference of the light transmissive substrate 10a. In this case, the barcode reading unit 17 shown in FIG. 4 is replaced with a magnetic head (not shown) and a reading circuit (not shown). The barcode reading sensor 17a is not in contact with the barcode 25. However, the magnetic head is brought in contact with the surface of the magnetic recording medium 20 to read the managing information.

Further, the embodiment is described with the three-dimensional optical recording medium OM for recording the optical information using holographic (interference) method. However, the present invention is not limited to this. For example, a three-dimensional optical recording medium using two photon absorbing material for optical information recording layer can be used. The two photon absorbing material may be made of only a compound in which some chemical or physical change occurs in itself; a two photon absorbing material further containing a second compound in which some chemical or physical change is induced by two photon absorption or multi-photon absorption; or a two photon absorbing material containing a third compound having a function for adjusting these recording processes in addition to the second compound. Such a two photon absorbing material is listed in Japanese laid-open patent application publication No. 2002-172864.

In the above-mentioned embodiment, the optical recording medium OM is formed in a disk. However, the present invention is not limited to this, but may have a card shape.

FIG. 7 shows a third modification for illustrating this. The optical recording medium OM1 has the RFID tag and the barcode 15 at a periphery 114 thereof.

Further, in the three-dimensional optical recording medium, a piece of the managing information is previously recorded in the recording portion, for example, in a production process or before sale. Therefore, a ROM (Read Only Memory), a write-once memory, a read-write memory can be used.

In addition, the recording portion may store another piece of the managing information in addition to the piece of the managing information. Therefore, a write-once memory, a read-write memory can be used. In the case of the barcode 15, another barcode may be additionally printed with a position shift in a predetermined rotational direction. The RFID tag 16 may have a sufficient recording capacity.

However, in the case of the write-once memory and the read-write memory, additional recording or rewriting of the managing information can be inhibited after sale. More specifically, inhibition information can be recorded in the initially recorded managing information.

Further, the managing information may further include a validation period.

The barcode reading sensor 17a includes a light source (not shown), for example, a laser diode (not shown), for projecting a light spot on the barcode 15 on the optical recording medium OM to detect the bars in the barcode 15 as the optical recording medium OM is rotated. Thus, bars in the barcode 15 are arranged in a rotation direction (scanning direction, or perimeter) of the optical recording medium OM. However, the light spot may be scanned over the barcode 15 in which the optical recording medium OM is not rotated. In this case, the bars can be arranged in a radial direction in addition to the case that the bars are arranged along the perimeter. In this case, the optical recording medium OM can be positioned to expose the barcode 15 through the opening 5.

The invention claimed is:

1. A three-dimensional optical recording medium comprising:
an optical information recording layer for three-dimensionally storing optical information; and
a recording portion that stores managing information of the three-dimensional optical recording medium.

2. The three-dimensional optical recording medium as claimed in claim 1, wherein the recording portion is optically readable.

3. The three-dimensional optical recording medium as claimed in claim 2, wherein the recording portion comprises a printed part.

4. The three-dimensional optical recording medium as claimed in claim 3, wherein the printed part comprises barcode.

5. The three-dimensional optical recording medium as claimed in claim 1, wherein the recording portion is electromagnetically readable.

6. The three-dimensional optical recording medium as claimed in claim 5, wherein the recording portion comprises an RFID tag.

7. The three-dimensional optical recording medium as claimed in claim 6, wherein the RFID tag is adhered to the three-dimensional optical recording medium other than the RFID tag.

8. The three-dimensional optical recording medium as claimed in claim 6, wherein the RFID tag is buried in the three-dimensional optical recording medium other than the RFID tag.

9. The three-dimensional optical recording medium as claimed in claim 1, wherein the recording portion comprises a magnetic recording material.

10. The three-dimensional optical recording medium as claimed in claim 1, wherein the three-dimensional optical recording medium is a disk.

11. The three-dimensional optical recording medium as claimed in claim 10, wherein the recording portion is disposed at a periphery of the three-dimensional optical recording medium.

12. The three-dimensional optical recording medium as claimed in claim 10, further comprising a center hole formed at a center of the disk, wherein the recording portion is disposed adjacently to the center hole.

13. The three-dimensional optical recording medium as claimed in claim 1, wherein the three-dimensional optical recording medium is a card.

14. The three-dimensional optical recording medium as claimed in claim 13, wherein the recording portion is disposed at a periphery of the three-dimensional optical recording medium.

15. An optical disk cartridge comprising:
a three-dimensional optical recording medium including an optical information recording layer for three-dimensionally storing optical information;
a cartridge case for housing the three-dimensional optical recording medium; and
a recording portion that stores managing information of the three-dimensional optical recording medium.

16. The optical disk cartridge as claimed in claim 15, wherein the recording portion is disposed at a periphery of the three-dimensional optical recording medium.

17. The optical disk cartridge as claimed in claim 15, wherein the recording portion is disposed at a periphery of the cartridge case.

18. The optical disk cartridge as claimed in claim 15, wherein the cartridge case has a light shielding property for the optical information recording layer.

19. The three-dimensional optical recording medium as claimed in claim 1, wherein a piece of the managing information is previously recorded in the recording portion.

20. The three-dimensional optical recording medium as claimed in claim 19, wherein the recording portion store another piece of the managing information in addition to the piece of the managing information.
